(19) United States
(12) Patent Application Publication
(10) Pub. No.: US 2017/0085079 A1
(43) Pub. Date: Mar. 23, 2017

(54) POWER SUPPLY DEVICE AND POWER SUPPLY DEVICE OPERATING METHOD

(71) Applicant: NEC Corporation, Tokyo (JP)

(72) Inventor: Takashi YAMANE, Tokyo (JP)

(73) Assignee: NEC Corporation, Tokyo (JP)

(21) Appl. No.: 15/123,360

(22) PCT Filed: Sep. 17, 2014
(86) PCT No.: PCT/JP2014/074505

§ 371 Date: Sep. 2, 2016

(30) Foreign Application Priority Data
Mar. 12, 2014 (JP) 2014-048999

(51) Int. Cl. H02J 1/00; H02M 7/04; H02J 3/00; H02M 3/04

(52) U.S. Cl. CPC H02J 1/00; H02M 3/04; H02M 7/04; H02J 3/00

(57) ABSTRACT

In order to solve the noise problem occurring in a switching power supply, provided is a power supply device having: a plurality of switching power supplies (POW1-n) that receive supply of electric power from a common primary side power supply (Vin); and a control unit (140) for controlling operations of the switching power supplies (POW1-n). The control unit (140) inputs control signals (St1-n) to the respective switching power supplies (POW1-n), the control signals (St1-n) indicating the timings of turning on switching elements. The switching power supplies (POW1-n) turn on the switching elements at timings in accordance with the control signals (St1-n) and draw current from the primary side power supply (Vin). A first control signal (St1) input to a first switching power supply (POW1) and a second control signal (St2) input to a second switching power supply (POW2) are adjusted so that the switching element of the first switching power supply (POW1) and the switching element of the second switching power supply (POW2) are not switched from OFF to ON at same timing.

### TECHNICAL FIELD

The present invention relates to a power supply device and a method for operating a power supply device.

### BACKGROUND ART

With sophisticated functionality and complexity of modulation methods typified by a digital coherent method, current consumed by a whole optical transceiver product is increasing drastically over the years, and the power consumption may sometimes become 10 times or more as large as a conventional optical transceiver product.

Further, due to decrease in power supply voltage of a modulation/demodulation Large Scale Integration (LSI) being a core, it is not unusual for a switching power supply that generates power for the modulation/demodulation LSI to output a secondary-side current of several tens of amperes, sometimes reaching 1.5 times or more as large as that in a transient state of the current consumption associated with a rapid change in the load.

Moreover, without limitation to a core component such as a modulation/demodulation LSI, decrease in voltage of a general semiconductor component is advancing, and power supplied from outside of an optical transceiver cannot be used as is. Accordingly, it has become essential for a product to mount therein a plurality of switching power supplies and generate power with various types of voltage. Note that it is not unusual these days to generate 10 types or more of voltage within a transceiver.

PTL 1 discloses a switching power supply circuit capable of suppressing generation of a noise by suppressing a start-up speed of voltage at a junction point between a high-side switch and a low-side switch under a no-load state, and suppressing self turn-on under a high-load state. The switching power supply circuit is a switching power supply circuit of a synchronous rectification type including a high-side switch and a low-side switch. The switching power supply circuit includes a removal part that removes electric charges from a control terminal of the low-side switch, and the removal part doubles removal capability at a lapse of a predetermined time after the removal part starts removal.

PTL 2 discloses a switching power supply device including a synchronous operation function for preventing generation of a low-frequency beat noise, and including versatility that can respond to a form of a power supply system. The switching power supply device consists of a power conversion unit having a main switching element and a switching element control circuit determining an on-timing of the main switching element, and a synchronous operation control circuit. The synchronous operation control circuit includes an operation mode setting signal input terminal for external input, and a synchronization clock signal input terminal to which a synchronization clock signal Sb obtained by frequency-dividing a system clock signal by a frequency division number n is input. The synchronous operation control circuit includes an oscillation circuit outputting an oscillation clock signal having a predetermined frequency, a selection circuit outputting the synchronization clock signal Sb or the oscillation clock signal, and a frequency multiplication circuit outputting a system clock signal obtained by multiplying the output signal of the selection circuit by n. The synchronous operation control circuit includes a first frequency division circuit 36 generating a driving clock signal obtained by frequency-dividing the system clock signal by m.

### CITATION LIST

### Patent Literatures

### [PTL 1] Japanese Unexamined Patent Application Publication No. 2012-44836

### [PTL 2] Japanese Unexamined Patent Application Publication No. 2012-151937

### SUMMARY OF INVENTION

### Technical Problem

The secondary side outputs of switching power supplies are stable due to optimal control by the respective switching power supplies, but noises generated on the primary side input are often left uncontrolled. As a result, a power supply to be input to an optical transceiver has a large amount of switching noises in a superposed manner caused by a plurality of switching power supplies mounted within the transceiver, often causing a problem of adverse effect on a peripheral component that uses the same power supply.

Herein, a problem of the present invention is described by use of referential diagrams of FIGS. 7 and 8. FIG. 7 illustrates an example of a configuration and FIG. 8 illustrates operation waveforms in the configuration in FIG. 7. Usually, a greater number of switching power supplies are mounted, but herein, the number of switching power supplies is three for simplicity.

FIG. 7 illustrates three switching power supplies POW1 to 3 (210 to 212) that use an identical primary side power supply Vin (201). SW1 to 3 in FIG. 8 are switching waveforms indicating ON/OFF states of switching elements of the respective switching power supplies POW1 to 3 (210 to 212) (waveforms indicating timings for drawing current from the primary side power supply Vin (201)). Iin (202) indicates current flowing in the primary side power supply Vin (201), that is, a sum total of the current to be drawn by the three switching power supplies POW1 to 3 (210 to 212) from the primary side power supply Vin (201).

At a portion where ON states of the switching elements of the three switching power supplies POW1 to 3 (210 to 212) overlap (for example, a portion of 300 in FIG. 8), the switching power supplies POW1 to 3 (210 to 212) draw current simultaneously from the primary side power supply Vin (201), and thus extremely large current flows instantaneously (at a portion of 301). As a result, a noise generated at the primary side power supply (voltage) Vin (201) also becomes the maximum (at a portion of 302). Note that in a general switching power supply, an amount of current increases in proportion to time when a switching element is ON.

Further, at a time of rapid change in load, in which current on the secondary side rapidly increases, such as at a time of startup of a modulation/demodulation LSI or the like, current fluctuation (cc a primary side power supply noise) much larger than the one illustrated in this diagram results in occurring.

The respective switching power supplies POW1 to 3 (210 to 212) have different switching frequencies as well as different switching timings (see SW1 to 3), and thus noises generated in the primary side voltage Vin (201) and the primary side current Iin (202) have no regularity, resulting in having wide frequency components. Since it is difficult to create a noise filter covering such a wide range of frequency, a large amount of noises that are unable to be removed by a filter result in remaining.

The present invention addresses the task of providing a new means for solving a noise problem occurring in a switching power supply.

### Solution to Problem

According to the present invention, provided is a power supply device including:

a plurality of switching power supplies that receive supply of electric power from a common primary side power supply; and

a control means for controlling operations of the plurality of switching power supplies, wherein

the control means inputs control signals indicating timings for turning on switching elements to the plurality of respective switching power supplies,

the plurality of switching power supplies turn on the switching elements at timings in accordance with the control signals and draw current from the primary side power supply, and

a first of the control signals input to a first of the switching power supplies and a second of the control signals input to a second of the switching power supplies are adjusted so that the switching element of the first switching power supply and the switching element of the second switching power supply are not switched from OFF to ON at same timing.

Further, according to the present invention, provided is a method for controlling a power supply device, the method causing a computer to execute a control process for controlling operations of a plurality of switching power supplies that receive supply of electric power from a common primary side power supply, wherein

in the control process, control signals indicating timings for turning on switching elements are input to the plurality of respective switching power supplies, and the plurality of switching power supplies turn on the switching elements at timings in accordance with the control signals and draw current from the primary side power supply, and

a first of the control signals input to a first of the switching power supplies and a second of the control signals input to a second of the switching power supplies are adjusted so that the switching element of the first switching power supply and the switching element of the second switching power supply are not switched from OFF to ON at same timing.

### Advantageous Effects of Invention

The present invention achieves a new means for solving a noise problem occurring in a switching power supply.

### BRIEF DESCRIPTION OF DRAWINGS

The above-described objective and other objectives, features, and advantages are more apparent from the following preferred exemplary embodiments and the accompanying drawings.

FIG. 1 is a diagram illustrating an example of a functional block diagram of a power supply device according to the present exemplary embodiment.

FIG. 2 is a diagram illustrating an example of a functional block diagram of a power supply device according to the present exemplary embodiment.

FIG. 3 is a diagram illustrating an example of operation waveforms of a power supply device according to the present exemplary embodiment.

FIG. 4 is a diagram illustrating an example of a functional block diagram of a power supply device according to the present exemplary embodiment.

FIG. 5 is a diagram illustrating an example of operation waveforms of a power supply device according to the present exemplary embodiment.

FIG. 6 is a diagram illustrating an example of a functional block diagram of a power supply device according to the present exemplary embodiment.

FIG. 7 is a diagram illustrating an example of a functional block diagram of a power supply device according to a referential example.

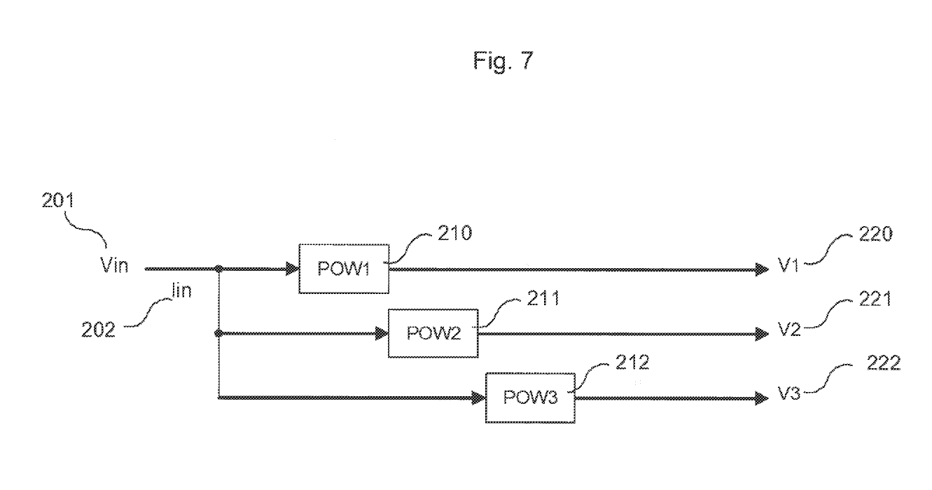

FIG. 8 is a diagram illustrating an example of operation waveforms of a power supply device according to a referential example.

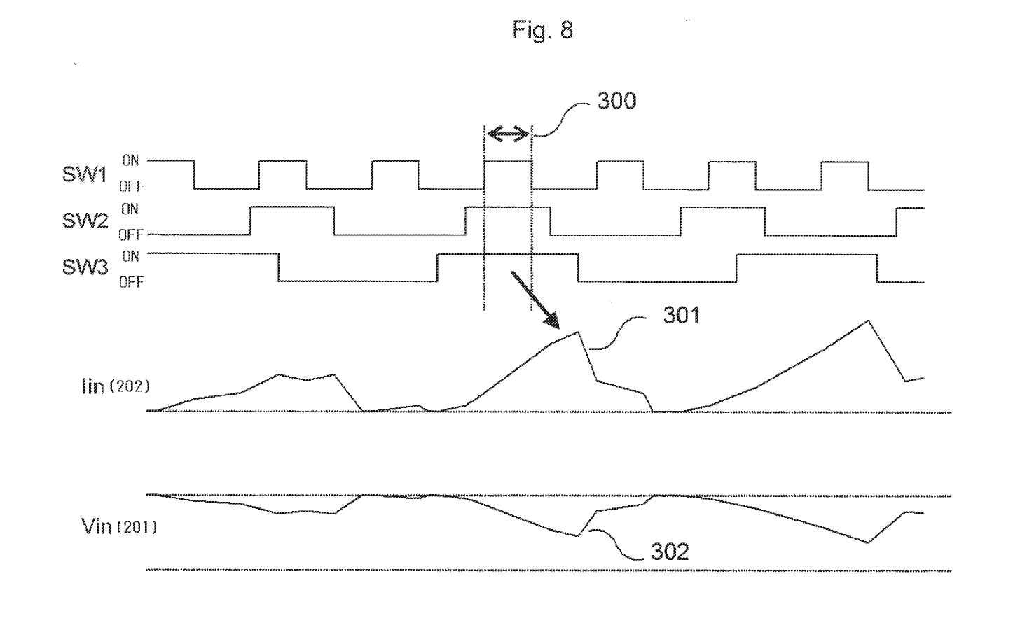

### DESCRIPTION OF EMBODIMENTS

The following will describe exemplary embodiments of the present invention with use of the drawings. Note that the same referential numerals are assigned for the same components and the description therefor is omitted as appropriate.

A power supply device according to the present exemplary embodiments is implemented by any combination of hardware and software, mainly by a Central Processing Unit (CPU), a memory, a program loaded in a memory (including a program previously stored in a memory at the stage for shipment of the device, as well as a program downloaded from a storage medium such as a compact disc (CD), a server on the Internet, or the like), a storage unit such as a hard disk that stores the program, and a network connection interface of an arbitrary computer. Further, it should be understood by a person skilled in the art that there are a variety of modifications for a method or a device for implementing the same.

Note that functional block diagrams used in the following description of the exemplary embodiments indicate blocks of functional units rather than a structure of hardware units. In these diagrams, each device is described as being implemented by a single instrument, however, the means for implementing the same is not limited thereto. In other words, the configuration may be physically separated or logically separated.

### First Exemplary Embodiment

Firstly, the concept of a power supply device according to the present exemplary embodiment is described. The power supply device according to the present exemplary embodiment uses a control unit that is configured by a microcomputer, a Digital Signal Processor (DSP), a Field Programmable Gate Array (FPGA), and the like to synchronously operate a plurality of switching power supplies that receive supply of electric power from a common primary side power supply. This synchronous operation reduces the noise problem occurring in a switching power supply.

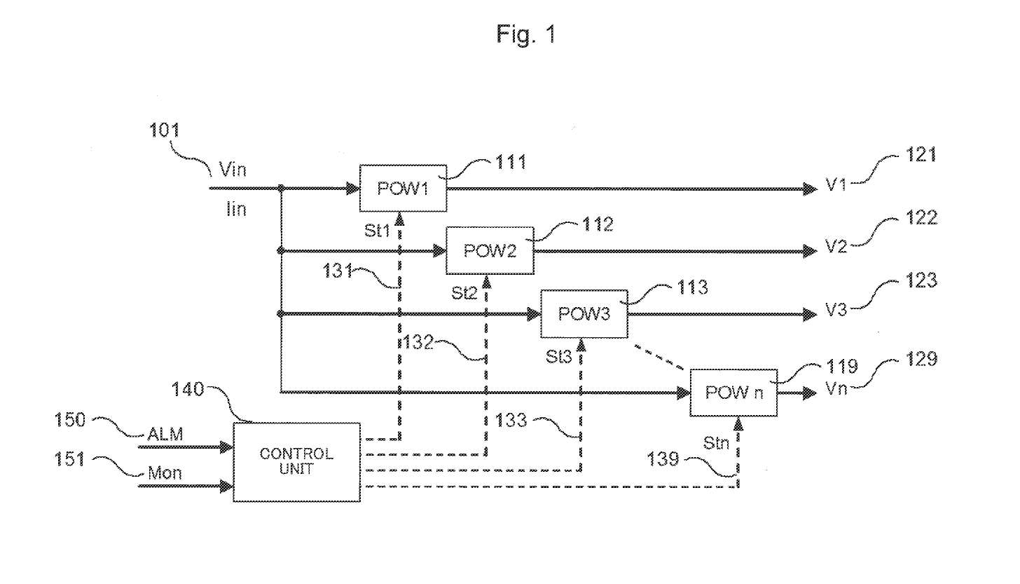

An example configuration of a power supply device according to the present exemplary embodiment is illustrated in FIG. 1. The power supply device according to the present exemplary embodiment is mounted on, for example, an optical transceiver product.

As illustrated in FIG. 1, the power supply device according to the present exemplary embodiment has a plurality of switching power supplies POW1 to n (111 to 119) that receive supply of electric power from a common primary side power supply Vin (101). Note that n is an integer equal to or greater than 2. Secondary side output voltages from the respective switching power supplies POW1 to n (111 to 119) are denoted by V1 to n (121 to 129). The secondary side output voltages V1 to n (121 to 129) are respectively input to different loads (not illustrated).

The switching power supplies POW1 to n (111 to 119) is configured by, for example, DC-DC converters or AC-DC converters. In the following, the description is made on the premise that the switching power supplies POW1 to n (111 to 119) are DC-DC converters. When the switching power supplies POW1 to n (111 to 119) are replaced from DC-DC converters to AC-DC converters, there is a difference in that input voltage and current are alternating current waveforms, but the operation of the power supply device according to the present exemplary embodiment is the same.

The plurality of respective switching power supplies POW1 to n (111 to 119) receive inputs of control signals St1 to n (131 to 139) indicating timings for turning on switching elements. The plurality of switching power supplies POW1 to n (111 to 119) turn on the switching elements at the timings in accordance with the input control signals St1 to n (131 to 139) and draw current from the primary side power supply Vin (101). For example, the plurality of switching power supplies POW1 to n (111 to 119) turn on the switching elements at prescribed timings in accordance with the control signals St1 to n (131 to 139), and generate Pulse Width Modulation (PWM) signals to perform power conversion.

In the case of the present exemplary embodiment, by adjusting the control signals St1 to n (131 to 139) individually (by shifting the timings for switching the switching elements from OFF to ON, by changing the cycles of the timings for switching the switching elements from OFF to ON, or the like), it is possible for the plurality of switching power supplies POW1 to n (111 to 119) to individually adjust the timings or the like for switching ON/OFF of the switching elements.

A control unit (140) controls the operations of the plurality of switching power supplies POW1 to n (111 to 119). Specifically, the control unit (140) inputs the above-described control signals St1 to n (131 to 139) to the plurality of switching power supplies POW1 to n (111 to 119), respectively. The control unit (140) adjusts the control signals St1 to n (131 to 139) individually (by shifting the timings for switching the switching elements from OFF to ON, by changing the cycles of the timings for switching the switching elements from OFF to ON, or the like). Thereby, the control unit (140) can input the adjusted control signals St1 to n (131 to 139) to the plurality of switching power supplies POW1 to n (111 to 119).

For example, the control unit (140) may adjust a first control signal St1 to be input to a first switching power supply POW1 (111) and a second control signal St2 to be input to a second switching power supply POW2 (112) so that the switching element of the first switching power supply POW1 (111) and the switching element of the second switching power supply POW2 (112) are not switched from OFF to ON at the same timing.

Further, the control unit (140) may adjust the first control signal St1 to be input to the first switching power supply POW1 (111) and the second control signal St2 to be input to the second switching power supply POW2 (112) so that the switching element of the first switching power supply POW1 (111) and the switching element of the second switching power supply POW2 (112) are not switched from ON to OFF at the same timing.

This adjustment is possible by grasping times for which the plurality of respective switching power supplies POW1 to n (111 to 119) sustain ON states after switching the switching elements from OFF to ON. For example, when the first switching power supply POW1 (111) sustains ON state for a time of t1 seconds and the second switching power supply POW2 (112) sustains ON state for a time of t2 seconds (t1>t2)), turning on the switching element of the second switching power supply POW2 (111) in (t1−t2) seconds after turning on the switching element of the first switching power supply POW1 (111) results in these switching elements being switched from ON to OFF at the same timing. Thus, the control unit (140) adjusts the first control signal St1 and the second control signal St2 so that the switching element of the second switching power supply POW2 (111) is turned on at a timing other than in (t1−t2) seconds after turning on the switching element of the first switching power supply POW1 (111).

Note that the means by which the control unit (140) grasps times for the plurality of respective switching power supplies POW1 to n (111 to 119) to sustain ON states after switching the switching elements from OFF to ON is not limited to particular means. For example, the control unit (140) may estimate the times (estimate increases and decreases from prescribed times) based on a monitor (Mon) signal (151) for monitoring a state of a main signal acquired from an optical reception unit. For example, the Mon signal (151) is data indicating the received optical power (the intensity of an optical signal input to an optical transceiver). The control unit (140) can monitor the Mon signal (151) with a threshold value and predict that the amount of power consumed by the optical reception unit and a modulation/demodulation unit increases by a certain amount when the Mon signal (151) exceeds the threshold value. “Increase in power consumption amount=Current consumption amount∝Increase in ON time of the POW (DC-DC converter)” is established. Note that the amount of power consumption increased by the operation start of a demodulation circuit hardly fluctuates (the amount of power consumption increases by approximately a fixed amount) in a general transceiver.

In addition, the control unit (140) may adjust the first control signal and the second control signal so that the switching element of the first switching power supply POW1 (111) and the switching element of the second switching power supply POW2 (112) are not turned on at the same time. This adjustment is possible by grasping times for the plurality of respective switching power supplies POW1 to n (111 to 119) to sustain ON states after switching the switching elements from OFF to ON. For example, when the first switching power supply POW1 (111) sustains ON state for a time of t1 seconds, the control unit (140) adjusts the first control signal St1 and the second control signal St2 so that the switching element of the second switching power supply POW2 (111) is not turned on within t1 seconds after turning on the switching element of the first switching power supply POW1 (111).

Note that the control unit (140) may receive input of an alarm (ALM) signal (150). The control unit (140) may then adjust the control signals St1 to n (131 to 139) based on the ALM signal (150). This configuration is described in the following exemplary embodiment.

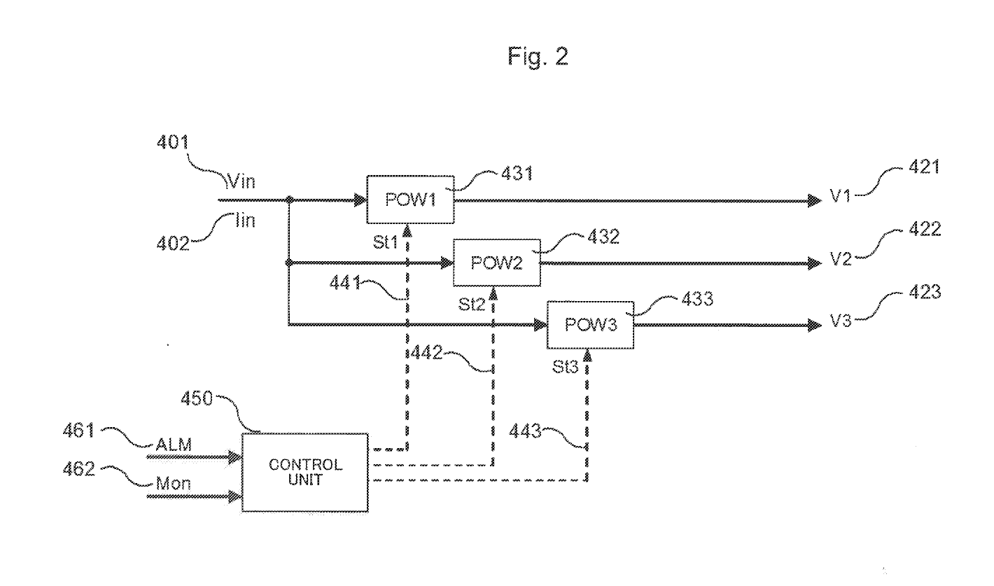

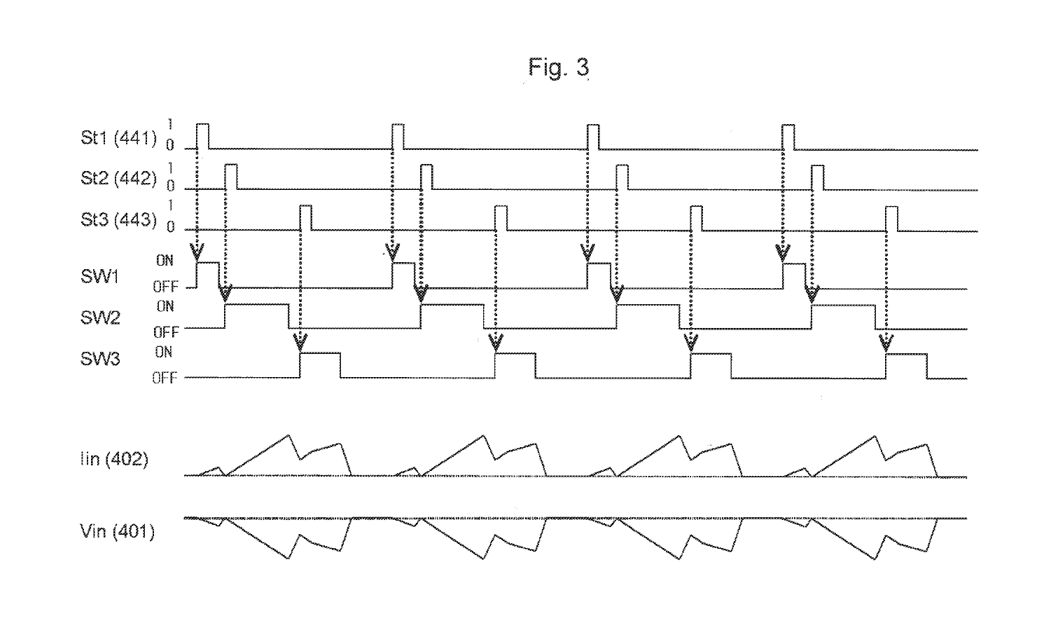

Here, with use of FIGS. 2 and 3, there is described an example of processing in which the control unit (140) adjusts the plurality of control signals St1 to n (131 to 139).

FIG. 2 illustrates an example configuration of a power supply device according to the present exemplary embodiment. This diagram illustrates the case of having three switching power supplies POW1 to 3 (431 to 433) for simplicity of the description. FIG. 3 illustrates operation waveforms in the configuration in FIG. 2. Here, the operations in steady states in which there are no rapid changes in loads connected to the switching power supplies POW1 to 3 (431 to 433) are described.

As illustrated in FIG. 2, a control unit (450) inputs control signals St1 to 3 (441 to 443) to the respective three switching power supplies POW1 to 3 (431 to 433). The plurality of switching power supplies POW1 to 3 (441 to 443) turn on switching elements at prescribed timings in accordance with the control signals St1 to 3 (441 to 443), and generate PWM signals to perform power conversion.

FIG. 3 illustrates waveforms of the respective control signals St1 to 3 (441 to 443), ON/OFF states of the switching elements (SW1 to 3) of the respective switching power supplies POW1 to 3 (441 to 443), a waveform of a primary side Iin (402), and a waveform of a primary side Vin (401).

The illustrated control signals St1 to 3 (441 to 443) are time series data indicating either of a binary value (e.g., 0 and 1). The control signals St1 to 3 (441 to 443) indicates, using the binary value, the timings for switching the switching elements from OFF to ON and the cycles thereof. In the case of the example illustrated in the diagram, a timing at which a value switches from 0 to 1 indicates the timing for switching the switching element from OFF to ON. Observing SW1 to 3 shows that the switching elements of the respective switching power supplies POW1 to 3 (431 to 433) are switched from OFF to ON at the timings when the values of the respective control signals St1 to 3 (441 to 443) switch from 0 to 1. ON states of the switching elements continue for a prescribed time determined for each of the switching power supplies POW1 to 3 (431 to 433), and subsequently shift to OFF states.

The control unit (450) inputs, to the plurality of respective switching power supplies POW1 to 3 (441 to 443), the control signals St1 to 3 (441 to 443) that have been adjusted so that the switching elements of the plurality of switching power supplies POW1 to 3 (441 to 443) are not switched from OFF to ON at the same timing (adjusted so that the timings when the values switch from 0 to 1 are different from one another) as illustrated in FIG. 3.

Note that the control signals St1 to 3 (441 to 443) illustrated in FIG. 3 have been further adjusted so that the switching elements of the plurality of switching power supplies POW1 to 3 (441 to 443) are not switched from ON to OFF at the same timing. Further, the control signals St1 to 3 (441 to 443) illustrated in FIG. 3 have been adjusted so that the switching elements of the plurality of switching power supplies POW1 to 3 (441 to 443) are not turned on at the same time.

In this manner, the present exemplary embodiment allows the switching power supplies POW1 to 3 (441 to 443) to disperse timings for drawing current Iin 402 from the primary side power supply Vin 401, and thus enables to suppress current noises generated on the primary side, as illustrated by SW1 to 3 in FIG. 3.

Further, by synchronously operating the plurality of switching power supplies POW1 to 3 (441 to 443), the frequency components included in generated noises are fixed (not spreading in a random manner, but becoming approximate to fixed waveforms. See Iin (402) and Vin (401) in FIG. 3.). Therefore, it becomes easy to remove noises by a smoothing circuit and a power supply noise filter.

Note that ON/OFF phase control for the switching power supplies may be set in the control unit (450) beforehand.

### Second Exemplary Embodiment

A power supply device according to the present exemplary embodiment is different from the first exemplary embodiment in that the device determines operation states of a plurality of respective loads that receive supply of electric power from a plurality of respective switching power supplies, and adjusts control signals based on the grasped operation states. Other configurations are the same as the first exemplary embodiment. An example configuration of the power supply device according to the present exemplary embodiment is illustrated in FIG. 1 similarly to the first exemplary embodiment.

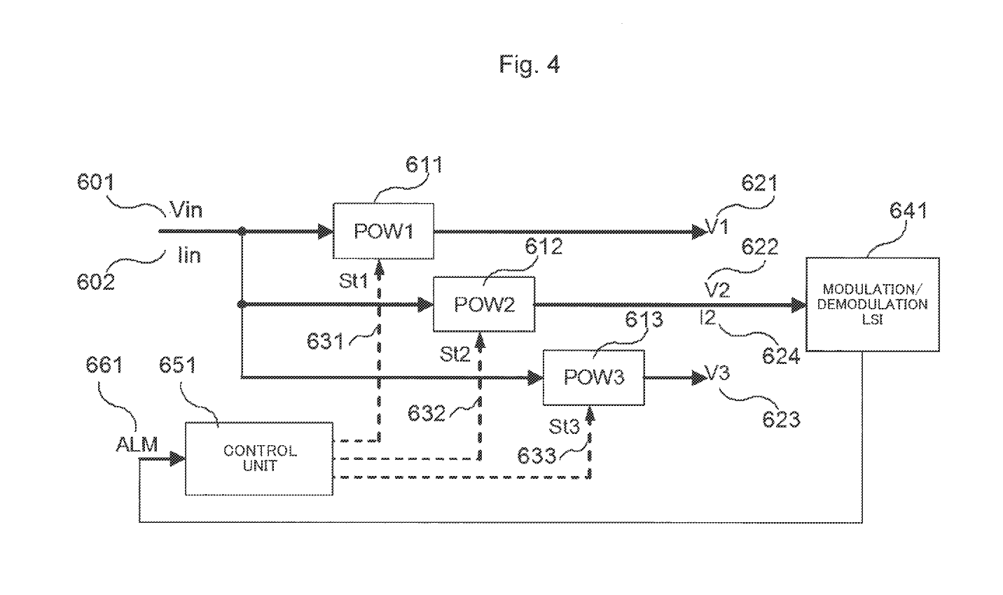

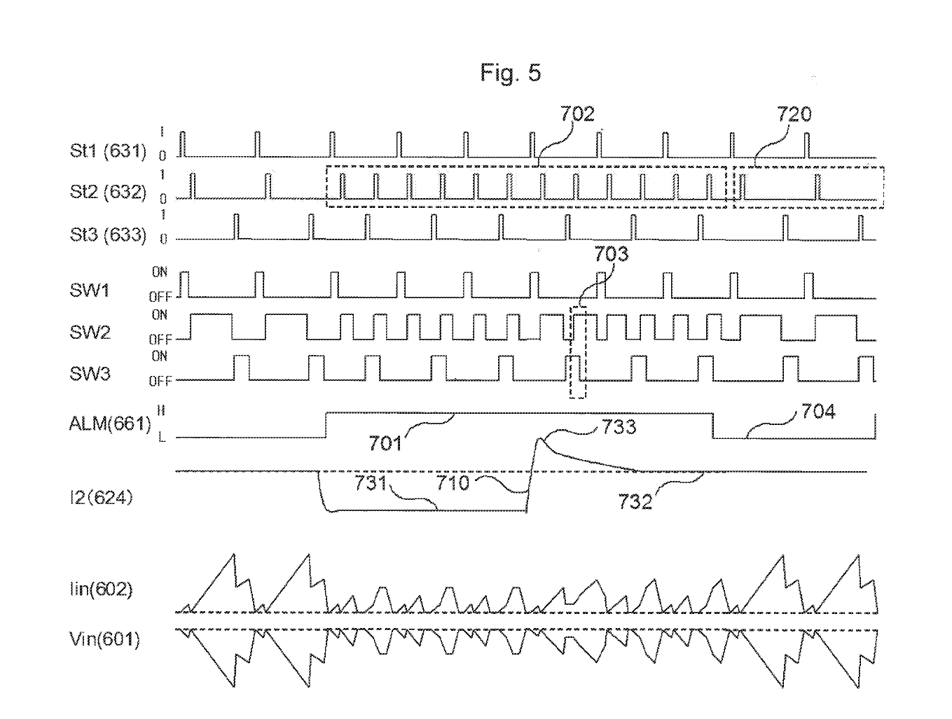

Here, with use of FIGS. 4 and 5, there is described an example of processing for adjusting the plurality of control signals St1 to n (131 to 139) by the control unit (140) illustrated in FIG. 1.

FIG. 4 illustrates an example configuration of a power supply device according to the present exemplary embodiment. The diagram illustrates the case of having three switching power supplies POW1 to 3 (611 to 613) for simplicity of the description. FIG. 5 illustrates operation waveforms in the configuration in FIG. 4. Here, the operations in the case in which there are rapid changes in loads connected to the switching power supplies POW1 to 3 (611 to 613) are described.

As illustrated in FIG. 4, a control unit (651) inputs control signals St1 to 3 (631 to 633) to the respective three switching power supplies POW1 to 3 (611 to 613). The plurality of switching power supplies POW1 to 3 (611 to 613) turn on switching elements at prescribed timings in accordance with the control signals St1 to 3 (631 to 633), and generate PWM signals to perform power conversion.

As illustrated in FIG. 4, the switching power supply POW2 (612) serves as a power supply for a modulation/demodulation LSI (641). The load that receives supply of electric power from the switching power supplies POW1 to 3 (611 to 613), for example, the modulation/demodulation LSI (641), generates an ALM signal (661) indicating a non-conducting state (701) and a conducting state (704) of a main signal, and input the ALM signal (661) to the control unit (651). The control unit (651) adjusts the control signals St1 to 3 (631 to 633) to be input to the respective switching power supplies POW1 to 3 (611 to 613) based on the ALM signal input from the load. For example, the control unit (651) adjusts the control signal St2 (632) to be input to the switching power supply POW2 (612) based on the ALM signal (661) input from the modulation/demodulation LSI (641).

The conducting state represents a state in which a signal is input to a load and the load is operating. Examples include a state in which a demodulatable signal is input to the modulation/demodulation LSI (641) and the modulation/demodulation LSI is normally performing demodulation processing. In this state, the current consumption of the load becomes the maximum. On the other hand, the non-conducting state represents a state in which no signal is input to a load and the load is not operating. Examples include a state in which no demodulatable signal is input to the modulation/demodulation LSI (641) and the modulation/demodulation LSI is not performing demodulation processing. In this state, the current consumption of the load becomes the minimum.

The processing by a load of generating an ALM signal indicating a conducting state and a non-conducting state and inputting the ALM signal to the control unit (651) can be achieved according to a prior art. Note that the control unit (651) is capable of grasping the correspondence relations between a load and switching power supplies that supply electric power to the load by the means as follows, for example. For a general optical transceiver, a power supply voltage V2 (622) of the modulation/demodulation LSI (641) is often a special voltage that is not likely to be used commonly, and inevitably requires the switching power supply POW2 (612) that is dedicated to power supply for the modulation/demodulation LSI (641). Further, because of the limitation or the like on a power-on sequence for each of components, an LSI, and the like, it is common to mount a load that consumes a large amount of current with switching power supplies (DC-DC converters or the like) that are dedicated to the respective loads. In this case, since the correspondence relations between the load and the switching power supplies that supply electric power to the load are determined in advance, the control unit (651) may hold the information. In this case, it is often the case that the association may be made as follows: an ALM signal from the load=Increase in current consumption. Note that in the case when a single switching power supply supplies power source to a plurality of blocks that consume a large amount of current, the similar processing is possible by generating an ALM signal for each of the blocks and inputting the ALM signal to the control unit (651).

The control unit (651) determines whether a state of a load is a conducting state or a non-conducting state, and adjusts the control signal to be input to the switching power supply that supplies electric power to the load in accordance with a result of determination. Specifically, the control unit (651) adjusts the control signal so that a frequency of OFF-to-ON switching of the switching element in the non-conducting state becomes larger than the frequency in the conducting state. Upon detecting a change (increase or decrease) in the frequency, the switching power supply POW2 (612) varies (decreases or increases) a duration time (a pulse width of SW2) for which the switching element is turned on in accordance with the change in the frequency.

For example, the control unit (651) may hold information beforehand indicating the frequency in the conducting state and the frequency in the non-conducting state for each of the switching power supplies POW1 to 3 (611 to 613). Further, the plurality of switching power supplies POW1 to 3 (611 to 613) may respectively hold information beforehand indicating the duration time in the conducting state for which the switching element is turned on and the duration time in the non-conducting state for which the switching element is turned on. The control unit (651) and the switching power supplies POW1 to 3 (611 to 613) may perform the above-described processing based on these pieces of information.

FIG. 5 illustrates waveforms of the respective control signals St1 to 3 (631 to 633), ON/OFF states of the switching elements (SW1 to 3) of the respective switching power supplies POW1 to 3 (611 to 613), the ALM signal (1=the non-conducting state, 0=the conducting state), a waveform of a secondary side output current I2 (624) of the switching power supply POW2 (661), a waveform of Iin (602), and a waveform of Vin (601).

As a specific example of the ALM signal (661), a signal such as the Loss of Signal (LOS) or the Loss of Frame (LOF), which clarifies conduction/non-conduction of a main signal is conceivable. When a main signal of the modulation/demodulation LSI 641 is conducting, the ALM signal (661) becomes a Low level (704) and the secondary side current I2 (624) of the switching power supply POW2 (612) becomes the maximum. In contrast, it is assumed that when the main signal is not conducting, the ALM signal (661) becomes a High level (701) and the secondary side current I2 (624) of the switching power supply POW2 (612) becomes the minimum.

There arises a difference in the secondary side output current I2 (624) of the switching power supply POW2 (612) by a current of several tens of amperes between the non-conducting state (701) and the conducting state (704) of the main signal of the modulation/demodulation LSI (the difference between the time 731 and the time 732 is several tens of amperes). Further, at the time of signal conduction start (710), the circuits within the modulation/demodulation LSI (641) concurrently perform startup processing (rapid change in the load). This rapid change in the load instantaneously increases the current consumption, possibly reaching 1.5 times or more (733) greater than the power consumption at the time of the stable conducting state (732).

The control unit (651) monitors the ALM signal (661), and, in the case of the non-conducting state (701), a current draw may occur in future due to the rapid change in the load, therefore, the control unit changes a switching frequency (frequency of switching OFF-to-ON) of the switching power supply POW2 (612) to be M (M is 1 or greater) times (702) larger than that in the conducting state (704). Note that M=2 in FIG. 5. Upon detection of the increase in the frequency, the switching power supply POW2 (612) decreases (e.g., to 1/M times) the duration time (the pulse width of SW2) for which the switching element is turned on in accordance with the change in the frequency. Note that in FIG. 5, a pulse of SW2 is one half. As described above, the switching frequency and the duration time for which the switching element is turned on are determined in advance for the conducting state (704) and the non-conducting state (701), and the control unit (651) and the switching power supply POW2 (612) may perform the above-described processing in accordance therewith.

When the ALM signal (661) is High (701), that is, when the signal is in the non-conducting state, it is conceivable that the secondary side current I2 (624) of the switching power supply POW2 (612) is the minimum. In other words, it is predicted that subsequently, the secondary side current I2 (624) of the switching power supply POW2 (612) may rapidly increase toward the maximum value due to the startup of the circuits within the modulation/demodulation LSI (641) at the time of starting signal conduction. Thus, the switching frequency of the switching power supply POW2 (612) is increased (702), thereby increasing the response speed to the rapid change in the load and reducing a current sink for each single switching.

It is conceivable that the M-times (M is 1 or greater) switching frequency may result in overlapping of the switching timings (e.g., 703) of the switching power supply POW2 (612) and the other switching power supplies POW 1 and 3 (611 and 613). However, increasing (e.g., to twice) the switching frequency can reduce (e.g., to one half) the amount of current draw for each single switching, and thus hardly causes a problem as serious as the conventional configuration. Nonetheless, in general, when the switching frequency rises, the power conversion efficiency tends to slightly drop, and thus the power consumption increases. In other words, a high-speed following capability (high slew rate) and the suppression of the power supply noises generated in the primary side Vin (601) are performed at the temporal expense of the power conversion efficiency (power consumption). By returning the switching frequency to the original at the point where the load current enters the steady state (720) after the rapid change in the load, the power conversion efficiency is maximized.

Note that in FIG. 5, the rising (710) of the load current I2 (624) when the ALM signal (661) is High (701) indicates that the modulation/demodulation LSI (641) is activated upon receiving an optical input signal. Thus, the pulse width of SW2 also becomes wide temporarily at this timing (immediately after 733). Subsequently, the current consumption 12 (624) converges to the steady state (710→733→732). Accordingly, the pulse of SW2 also becomes narrow (returns to the state before change). However, even when the modulation/demodulation LSI (641) is activated, the ALM signal (661) maintains the High level (701) until the operation is stabilized. Thus, the switching frequency maintains a high state until the ALM signal (661) becomes Low level (704). When the ALM signal (661) becomes Low level (704), the frequency of the control signal St2 decreases (720), and the pulse width of SW2 increases.

Note that when the modulation/demodulation LSI (641) is in the non-conducting state, not only the frequency of the switching power supply POW2 (612) that supplies electric power to the modulation/demodulation LSI (641), but all the frequencies of the switching power supplies POW1 to 3 (611 to 613) may be changed uniformly for simplicity of the operation (in consideration of the balance with the increase in power consumption caused by the decrease in the power conversion efficiency).

### <Modification>

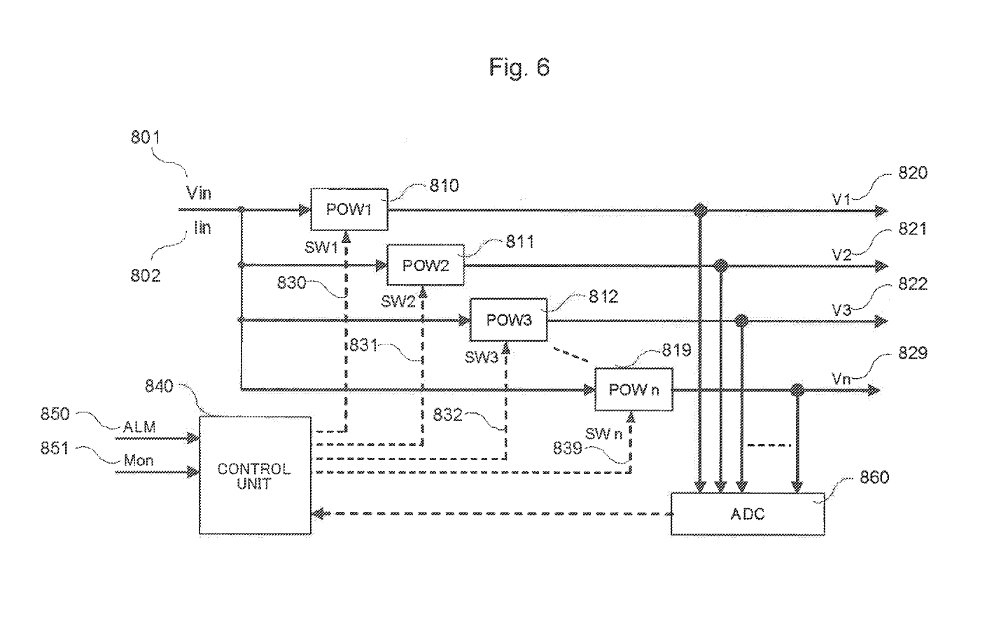

With use of FIG. 6, modifications of the first and second exemplary embodiments are described below.

A configuration of a control unit (840) is also conceivable which outputs not only control signals as references for timings or frequencies, but also directly sends switching signals (PWM signals) to control switching power supplies. Output voltages V1 to n (820 to 829) are monitored by an AD converter (ADC) (860), and a result of monitoring is collected by the control unit (840). The control unit (840) performs control operation such as the digital PID, and generates switching signals SW1 to SWn (PWM signals) (830 to 839). Other operations are the same as in the first and second exemplary embodiments.

In the following, examples of referential modes are supplemented.

1. A power supply device including:

a plurality of switching power supplies that receive supply of electric power from a common primary side power supply; and

a control means for controlling operations of the plurality of switching power supplies, wherein

the control means inputs control signals indicating timings for turning on switching elements to the plurality of respective switching power supplies,

the plurality of switching power supplies turn on the switching elements at timings in accordance with the control signals and draw current from the primary side power supply, and

a first control of the signal inputs to a first of the switching power supplies and a second control of the signal inputs to a second of the switching power supplies are adjusted so that the switching element of the first switching power supply and the switching element of the second switching power supply are not switched from OFF to ON at same timing.

2. The power supply device according to 1, wherein

the first control signal and the second control signal are adjusted so that the switching element of the first switching power supply and the switching element of the second switching power supply are not switched from ON to OFF at same timing.

3. The power supply device according to 1 or 2, wherein

the first control signal and the second control signal are adjusted so that the switching element of the first switching power supply and the switching element of the second switching power supply are not turned on at same time.

4. The power supply device according to any one of 1 to 3, wherein

the control means determines operation states of a plurality of respective loads that receive supply of electric power from the plurality of respective switching power supplies, and adjusts the control signals based on the grasped operation states.

5. The power supply device according to 4, wherein

the control means determines whether the state of the load is a conducting state or a non-conducting state, and adjusts the control signal to be input to the switching power supply that supplies electric power to the load in accordance with a result of the determination.

6. The power supply device according to 5, wherein

the control means adjusts the control signal so that a frequency of OFF-to-ON switching of the switching element becomes larger in the non-conducting state than a frequency in the conducting state.

7. A method for controlling a power supply device, the method causing a computer to execute a control process for controlling operations of a plurality of switching power supplies that receive supply of electric power from a common primary side power supply, wherein

in the control process, control signals indicating timings for turning on switching elements are input to the plurality of respective switching power supplies, and the plurality of switching power supplies turn on the switching elements at timings in accordance with the control signals and draw current from the primary side power supply, and

a first of the control signals input to a first of the switching power supplies and a second of the control signals input to a second of the switching power supplies are adjusted so that the switching element of the first switching power supply and the switching element of the second switching power supply are not switched from OFF to ON at same timing.

7-2. The method for controlling the power supply device according to 7, wherein

the first control signal and the second control signal are adjusted so that the switching element of the first switching power supply and the switching element of the second switching power supply are not switched from ON to OFF at same timing.

7-3. The method for controlling the power supply device according to 7 or 7-2, wherein

the first control signal and the second control signal are adjusted so that the switching element of the first switching power supply and the switching element of the second switching power supply are not turned on at same time.

7-4. The method for controlling the power supply device according to any one of 7 to 7-3, including

in the control process, determining operation states of a plurality of respective loads that receive supply of electric power from the plurality of respective switching power supplies, and adjusting the control signals based on the grasped operation states.

7-5. The method for controlling a power supply device according to 7-4, including

in the control process, determining whether the state of the load is a conducting state or a non-conducting state, and adjusting the control signal to be input to the switching power supply that supplies electric power to the load in accordance with a result of the determination.

7-6. The method for controlling a power supply device according to 7-5, including

in the control process, adjusting the control signal so that a frequency of OFF-to-ON switching of the switching element becomes larger in the non-conducting state than the frequency in the conducting state.

This application is based upon and claims the benefit of priority from Japanese Patent Application No. 2014-048999, filed on Mar. 12, 2014, the disclosure of which is incorporated herein in its entirety.

1. A power supply device comprising:
a plurality of switching power supplies that receive supply of electric power from a common primary side power supply; and
control unit for controlling operations of the plurality of switching power supplies, wherein
the control unit inputs a control signal indicating a timing for turning on a switching element to the plurality of respective switching power supplies,
the plurality of switching power supplies turn on the switching element at a timing in accordance with the control signal and draw current from the primary side power supply, and
a first of the control signals input to a first of the switching power supplies and a second of the control signals input to a second of the switching power supplies are adjusted so that the switching element of the first switching power supply and the switching element of the second switching power supply are not switched from OFF to ON at same timing.

2. The power supply device according to claim 1, wherein
the first control signal and the second control signal are adjusted so that the switching element of the first switching power supply and the switching element of the second switching power supply are not switched from ON to OFF at same timing.

3. The power supply device according to claim 1, wherein
the first control signal and the second control signal are adjusted so that the switching element of the first switching power supply and the switching element of the second switching power supply are not turned on at same time.

4. The power supply device according to claim 1, wherein
the control unit determines an operation state of a plurality of respective loads that receive supply of electric power from the plurality of respective switching power supplies, and adjusts the control signal based on the grasped operation state.

5. The power supply device according to claim 4, wherein
the control unit determines whether the state of the load is a conducting state or a non-conducting state, and adjusts the control signal to be input to the switching power supply that supplies electric power to the load in accordance with a result of the determination.

6. The power supply device according to claim 5, wherein
the control unit adjusts the control signal so that a frequency of OFF-to-ON switching of the switching element becomes larger in the non-conducting state than the frequency in the conducting state.

7. A method for controlling a power supply device, the method causing a computer to execute a control process for controlling operations of a plurality of switching power supplies that receive supply of electric power from a common primary side power supply, wherein
in the control process, a control signal indicating a timing for turning on a switching element is input to the plurality of respective switching power supplies, and the plurality of switching power supplies turn on the switching element at a timing in accordance with the control signal and draw current from the primary side power supply, and
a first of the control signals input to a first of the switching power supplies and a second of the control signals input to a second of the switching power supplies are adjusted so that the switching element of the first switching power supply and the switching element of the second switching power supply are not switched from OFF to ON at same timing.
